(19) United States
(12) Patent Application Publication
(10) Pub. No.: US 2008/0203896 A1
(43) Pub. Date: Aug. 28, 2008

(54) LIGHT EMISSION DEVICE AND DISPLAY DEVICE PROVIDED WITH THE SAME

(76) Inventors: Jae-Kwang Ryu, Yongin-si (KR); Jun-Sik Oh, Yongin-si (KR); Hee-Seong Jeong, Yongin-si (KR); Gun-Shik Kim, Yongin-si (KR); Jae-Woo Bae, Yongin-si (KR); Myun-Gi Shim, Yongin-si (KR); Do-Hyung Park, Yongin-si (KR); Kyu-Chan Park, Yongin-si (KR); Dong-Gun Moon, Yongin-si (KR); Sang-Yeol Hur, Yongin-si (KR)

Correspondence Address: CHRISTIE, PARKER & HALE, LLP, PO BOX 7068, PASADENA, CA, 91109-7068, US

(21) Appl. No.: 11/835,096

(22) Filed: Aug. 7, 2007

(30) Foreign Application Priority Data
Feb. 28, 2007 (KR) 10-2007-0020355

(51) Int. Cl. H01J 1/62

(52) U.S. Cl. 313/498

(57) ABSTRACT

A light emission device and a display device provided with the light emission device are provided. The light emission device includes an electron emission-type light emission panel for emitting light, and a diffusion member located on the light emission panel and for diffusing the light emitted from the light emission panel. The diffusion member includes a base having a first refractive index and two oppositely facing surfaces; and a diffusion region located in at least one of the surfaces of the base and having a second refractive index differing from the first refractive index.

### CROSS-REFERENCE TO RELATED APPLICATION

This application claims priority to and the benefit of Korean Patent Application No. 10-2007-0020355, filed on Feb. 28, 2007, in the Korean Intellectual Property Office, the entire content of which is incorporated herein by reference.

### BACKGROUND OF THE INVENTION

1. Field of the Invention

The present invention relates to a light emission device and a display device having the same. More particularly, the present invention relates to a light emission device and a display device having the same, in which the light emission device has a diffusion member.

2. Description of Related Art

A field emitter array (FEA) type of electron emission element includes one or more electron emission regions, and driving electrodes (e.g., cathode and gate electrodes functioning) for controlling electron emission of the one or more electron emission regions. In one embodiment, each of the electron emission regions is formed into a structure having a sharp tip and includes a material having a relatively low work function and/or a relatively large aspect ratio, such as molybdenum (Mo) or silicon (Si), and/or is formed from a carbon-based material such as carbon nanotubes, graphite, and diamond-like carbon, so as to effectively emit electrons when an electric field is formed around the electron emission regions under a vacuum atmosphere.

A plurality of the electron emission elements are arrayed on a first substrate to constitute an electron emission device. The electron emission device is combined with a second substrate, on which a light emission unit having phosphor layers and an anode electrode is formed, to constitute a light emission device. In addition to functioning as a display, the light emission device with this structure may function as a light source for a passive type display panel (or a non-emissive display panel).

### SUMMARY OF THE INVENTION

Aspects of embodiments of the present invention are directed to a light emission device that can evenly (or uniformly) diffuse visible light to thereby reduce (or minimize) an inactive region and, thereby ensuring uniform brightness, and a display having the light emission device.

A light emission device according to an exemplary embodiment of the present invention includes an electron emission-type light emission panel for emitting light, and a diffusion member located on the light emission panel and for diffusing the light emitted from the light emission panel. The diffusion member includes a base having a first refractive index and two oppositely facing surfaces; and a diffusion region located in at least one of the surfaces of the base and having a second refractive index differing from the first refractive index.

In one embodiment, a light transmissivity of the base is greater than a light transmissivity of the diffusion region.

In one embodiment, the diffusion region is located in each of the two surfaces of the base.

In one embodiment, the at least one of the surfaces faces toward an outside of the light emission device.

In one embodiment, a ratio of the second refractive index to the first refractive index is not less than about 1.2.

In one embodiment, the diffusion region includes a plurality of beads.

In one embodiment, a diameter of the beads is in a range from 0.1 μm to 100 μm.

In one embodiment, the diffusion region occupies not less than 2% of an overall volume of the base.

In one embodiment, the light emission panel includes: a first substrate; a second substrate opposing the first substrate; a light emission unit provided on the second substrate for emitting light; and an electron emission unit provided on the first substrate for emitting electrons toward the second substrate. The electron emission unit may include: a cathode electrode located on the first substrate; an electron emission region adapted to be electrically coupled to the cathode electrode; and a gate electrode electrically insulated from the cathode electrode.

A light emission device according to another exemplary embodiment of the present invention includes an electron emission-type light emission panel for emitting light, and a diffusion member located on the light emission panel and for diffusing the light emitted from the light emission panel. The diffusion member includes a plurality of beads, the beads being concentrated at a plate surface of the diffusion member.

In one embodiment, the plate surface of the diffusion member faces toward an outside of the light emission device.

In one embodiment, the diffusion member includes a base, and a diffusion region comprising the plurality of the beads, wherein the light emitted from the light emission panel passes through the base and is diffused by the diffusion member.

In one embodiment, the light emission panel includes: a plurality of active regions for emitting light; and an inactive region located between the active regions in a lattice configuration, wherein the light is diffused to the inactive region by the diffusion member.

A display device according to another exemplary embodiment of the present invention includes an electron emission-type light emission panel for emitting light, a diffusion member located on the light emission panel and for diffusing the light emitted from the light emission panel, and a display panel located on the diffusion member and for receiving the light passing through and diffused by the diffusion member. The diffusion member includes a base having a first refractive index and two oppositely facing surfaces, and a diffusion region located in at least one of the surfaces of the base and having a second refractive index differing from the first refractive index.

In one embodiment, a light transmissivity of the base is larger than a light transmissivity of the diffusion region.

In one embodiment, the diffusion region is located in each of the two surfaces of the base.

In one embodiment, the at least one of the surfaces faces toward an outside of the light emission device.

In one embodiment, a ratio of the second refractive index to the first refractive index is not less than 1.2.

In one embodiment, the display panel is a liquid crystal panel.

### BRIEF DESCRIPTION OF THE DRAWINGS

FIG. 1 is a partial exploded perspective view of a light emission device according to an exemplary embodiment of the present invention.

FIG. 2 is a partial sectional view of a light emission panel of FIG. 1.

FIG. 3 is a partial sectional view taken along line III-III of FIG. 1, illustrating the light emission device in an assembled state.

FIG. 4 is a partial sectional view of a light emission device according to another exemplary embodiment of the present invention.

FIG. 5 is an exploded partial perspective view of a display device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Hereinafter, like reference numerals refer to like elements.

In addition, when an element is referred to as being “on” another element, it can be directly on the another element or be indirectly on the another element with one or more intervening elements interposed therebetween. By contrast, when an element is referred to as being “directly on” another element, there are no intervening elements present.

Moreover, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below can also be referred to as a second element, component, region, layer, or section without departing from the teachings of the present invention.

The terminology used herein is for the purpose of describing particular embodiments and is not intended to limit the invention. As used herein, the singular forms “a,” “an,” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” “over,” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein are interpreted (or understood) accordingly.

Unless otherwise defined, all terms (including technical and scientific terms) used herein have the same meaning as commonly understood by one skilled in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In exemplary embodiments of the present invention, all devices that emit light to an external side are regarded as light emission devices. Therefore, all display devices that transmit information by displaying symbols, letters, numbers, or images can be regarded as light emission devices. A light emission device can be used as a display device or may use a light panel for providing a light to a passive display device. In addition, a panel can be a flat panel or a panel having a curvature. Moreover, a device that reflects external light can be regarded as a light emission device.

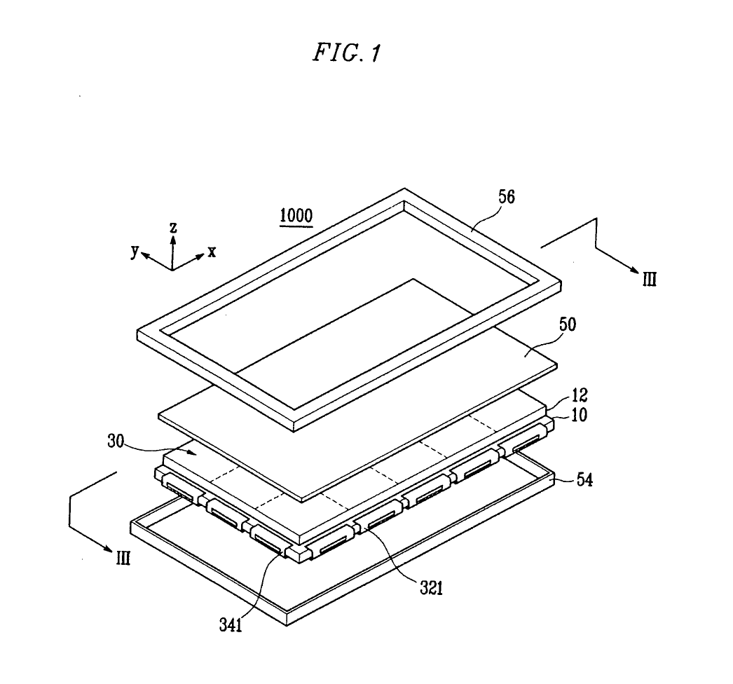

FIG. 1 illustrates a light emission device 1000 according to an exemplary embodiment of the present invention.

With reference to FIG. 1, the light emission device 1000 includes a light emission panel 30 and a diffusion member 50. The light emission device 1000 further includes a first securing member 54 and a second securing member 56 for securing and supporting the light emission panel 30 and the diffusion member 50.

The light emission panel 30 is a surface light emission-type panel, and radiates light by exciting a phosphor layer that is deposited over an area that may be predetermined. The light emission panel 30 includes a first substrate 10, a second substrate 12, an electron emission unit, and a light emission unit. In one embodiment, the light emission panel 30 functions as a light source for supplying light, and operates such that light emission pixels, which are indicated by the dotted lines in FIG. 1, are independently driven.

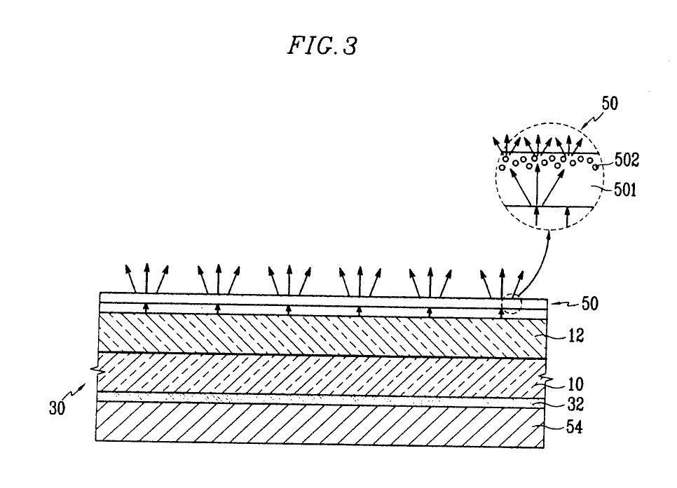

In this embodiment, the light emission panel 30 radiates light through electron emission. A plurality of gate lines and a plurality of data lines are formed on the electron emission-type light emission panel 30. The gate lines and the data lines are coupled to a printed circuit board 32 (see FIG. 3) respectively through drive integrated circuit (IC) packages 341 and 321. The printed circuit board 32 is located to a rear surface of the light emission panel 30. The printed circuit board 32 applies drive signals to the gate lines and the data lines of the light emission panel 30 to thereby drive the light emission panel 30. The diffusion member 50 is located above the light emission panel 30 to diffuse the light emitted from the light emission panel 30.

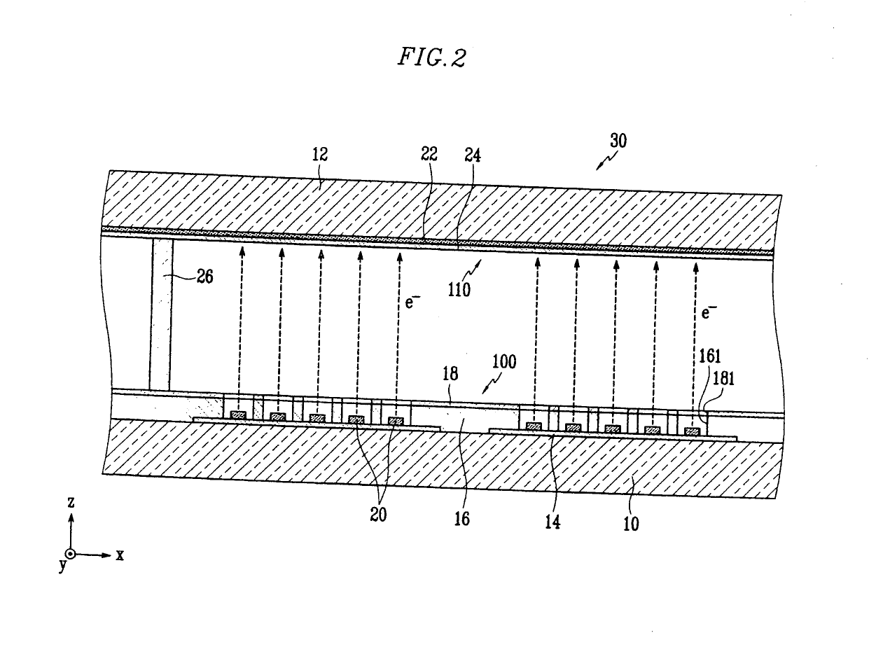

FIG. 2 illustrates a partial cross-sectional view of the light emission panel 30, in which an internal structure of the light emission panel 30 is enlarged for better illustration. The internal structure and operating principles of the light emission panel 30 will be described in more detail hereinafter.

With reference to FIG. 2, the light emission panel 30 includes the first substrate 10 and the second substrate 12 provided opposing each other in a substantially parallel manner and with a gap therebetween (wherein the gap may be predetermined). A sealing member is provided between the first and second substrates 10 and 12 along edge portions thereof to seal together the first and second substrates 10 and 12, thus forming a vacuum vessel. The interior of the vacuum vessel is kept to a degree of vacuum of about 10⁻⁶ Torr.

An electron emission unit 100 formed of an array of electron emission elements is provided on a surface of the first substrate 10 facing the second substrate 12, and a light emission unit 110 including a phosphor layer (or layers) 22 and an anode electrode 24 is provided on a surface of the second substrate 12 facing the first substrate 10. The first substrate 10 having the electron emission unit 100 and the second substrate 12 having the light emission unit 110 are combined to form the light emission panel 30.

The vacuum vessel with above structure may be applied to a variety of different types of electron emission-type displays, such as FEA-type (field emitter array-type), SCE-type (surface-conduction-emission-type), MIM-type (metal-insulator-metal-type), and MIS-type (metal-insulator-semiconductor-type). In the following description, an FEA-type light emission device is described in more detail by way of example.

Cathode electrodes 14 are formed on the first substrate 10 in a stripe pattern along a y-axis direction. A first insulation layer 16 is formed on the first substrate 10 covering the cathode electrodes 14, and gate electrodes 18 are formed on the first insulation layer 16 in a stripe pattern along an x-axis direction crossing (or perpendicular to) the cathode electrodes 14.

With this configuration, crossing regions are formed by the crossing of the cathode electrodes 14 and the gate electrodes 18. Each of the crossing regions forms a unit pixel. A plurality of electron emission regions 20 are formed on the cathode electrodes 14 at each area corresponding to the unit pixels.

The electron emission regions 20 of the above described configuration are formed of a material for emitting electrons when an electric field is applied thereto under a vacuum atmosphere, such as a carbon-based material and/or a nanometer-sized material. In one embodiment, the electron emission regions 20 may be formed of carbon nanotubes, graphite, graphite nanofibers, diamonds, diamond-like carbon, fullerene (C₆₀), silicon nanowires, or combinations thereof. Alternatively, the electron emission regions 20 may be formed to have a sharp tip structure using molybdenum (Mo) and/or silicon-based (Si-based) material.

Further, first openings 161 and second openings 181 are respectively formed in the first insulation layer 16 and the gate electrodes 18, such that pairs of one of the first openings 161 and one of the second openings 181 correspond in location to the electron emission regions 20 to thereby expose the electron emission regions 20 on the first substrate 10. That is, the electron emission regions 20 are located on the corresponding cathode electrodes 14 and exposed through the first and second openings 161 and 181. In this embodiment, each of the electron emission regions 20 is shown as being cylindrical in shape. However, the shape of the electron emission regions 20 is not limited to that shown in the drawings.

The phosphor layer 22 is formed on the surface of the second substrate 12 facing the first substrate 10. The phosphor layer 22 may be a white phosphor layer. The phosphor layer 22 may be formed on an entire active region of the second substrate 12, or may be formed in a pattern (that may be predetermined) in which one white phosphor layer is located corresponding to each of the pixel regions.

Alternatively, the phosphor layer 22 may be realized through a combination of red, green, and blue phosphor layers, in which case the red, green, and blue phosphor layers are provided in a pattern (that may be predetermined) for each of the pixel regions. In FIG. 2, the phosphor layer 22 is shown to be formed on the entire active region of the second substrate 12, as one white phosphor layer.

The anode electrode 24 is formed on the phosphor layer 22, and is made of a metal such as aluminum (Al). The anode electrode 24 is an acceleration electrode that receives an external high voltage (e.g., from 10 kV to 20 kV) to maintain the phosphor layer 22 at a high electric potential state. In addition, the anode electrode 24 can function to enhance luminance by reflecting visible light. That is, among the visible light emitted from the phosphor layer 22, a portion of the visible light that is emitted from the phosphor layer 22 to the first substrate 10 is reflected by the anode electrode 24 back toward the second substrate 12. In one embodiment, the phosphor layer 22 and the anode electrode 24 are layered in this order on the second substrate 12 such that the phosphor layer 22 is between the second substrate 12 and the anode electrode 24 (or adjacent to the second substrate 12). Accordingly, since the anode electrode 24 does not interfere with the light emitted from the phosphor layer 22, the anode electrode 24 may be formed of an opaque metal having a high degree of electrical conductivity.

In an alternative embodiment, the positions of the phosphor layer and the anode electrode may be reversed. That is, in the case where the anode electrode is made of a transparent conductive material such as indium tin oxide, the anode electrode may be located between the second substrate and the phosphor layer. In yet another embodiment, the anode electrode may be realized through a structure in which a metal layer is formed on a transparent conductive layer.

A plurality of spacers 26 are located between the first and second substrates 10 and 12 to resist atmospheric pressure applied to the vacuum vessel to thereby ensure that the gap between the first and second substrates 10 and 12 is uniformly maintained. In FIG. 2, only one of the spacers 26 is shown.

The light emission panel 30 forms a plurality of the unit pixels by the combination of the cathode electrodes 14 and the gate electrodes 18, and external voltages (which may be predetermined) are applied to the cathode electrodes 14, the gate electrodes 18, and the anode electrode 24. For example, in one embodiment, the cathode electrodes 14 function as scan electrodes for receiving a scan driving voltage, and the gate electrodes 18 function as data electrodes for receiving a data driving voltage. In another embodiment, the gate electrodes 18 function as scan electrodes for receiving a scan driving voltage, and the cathode electrodes 14 function as data electrodes for receiving a data driving voltage. Further, the anode electrode 24 receives a positive direct current voltage of, for example, from 10 kV to 20 kV, required for the acceleration of electron beams.

As a result, electric fields are formed around the electron emission regions 20 at the unit pixels where a voltage difference between the cathode and gate electrodes 14 and 18 is equal to or more than a threshold value so that electrons (e⁻) are emitted from the electron emission regions 20, as represented by the dotted lines in FIG. 2. The emitted electrons e⁻ are attracted by the high voltage applied to the anode electrode 24 to thereby collide with corresponding areas of the phosphor layer 22 to excite (and illuminate) the phosphor layer 22.

The above-described light emission panel 30 is driven using less power than a light-emitting diode-type (LED-type) or cold cathode fluorescent lamp-type (CCFL-type) light emission panel. Also, the light emission panel 30 allows for the intensity of light emission for each of the pixels of the panel 30 to be independently controlled. Driving of the pixels independently is related to driving of a display panel to be described below, and contributes to enhancing a dynamic contrast of images formed by the display panel.

In such driving, a plurality of active regions are formed for each pixel in the light emission panel 30. Further, inactive regions are formed in a lattice configuration between the pixels of the light emission panel 30 where electron beam emission of the electron emission regions 20 and light emission of the phosphor layer 22 do not occur.

In this embodiment, one or more diffusion members 50 for diffusing the light emitted from the light emission panel 30 are provided to reduce (or minimize) the inactive regions.

FIG. 3 is a partial sectional view taken along line III-III of FIG. 1, illustrating the light emission device 1000 in an assembled state. The enlarged circle in FIG. 3 illustrates a magnified view of a cross section of the diffusion member 50.

With reference to FIG. 3, the light emission device 1000 includes the diffusion member 50 located on the light emission panel 30. The diffusion member 50 diffuses the light emitted from the light emission panel 30 while the light passes therethrough.

The diffusion member 50 includes a base 501 having a thickness (that may be predetermined), and diffusion regions 502 located within the base 501. The base 501 is made of a transparent material to thereby allow the light emitted from the light emission panel 30 to be transmitted therethrough. The base 501 has a refractive index (that may be predetermined) such that light is refracted by and transmitted through the base 501. The diffusion regions 502 may be formed of a plurality of light-dispersing particles, such as beads, which are dispersed within a surface of the base 501. A diameter of each of the beads of the diffusion regions 502 is in a range from 0.1 μm to 100 μm.

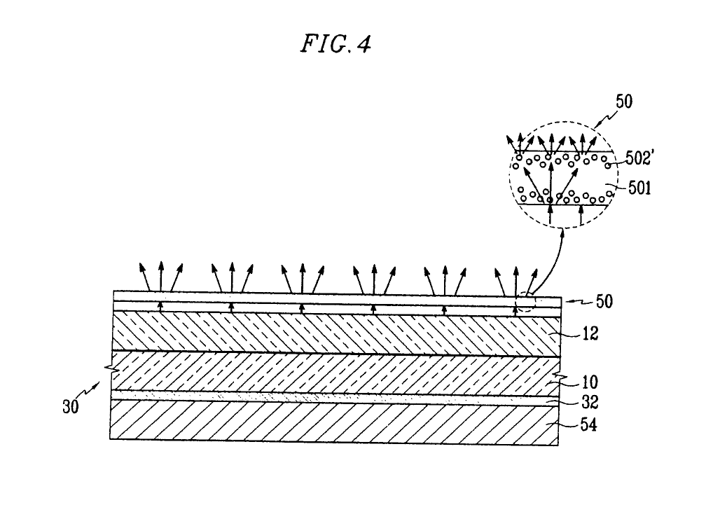

The base 501 may be plate-shaped having a first surface (or first plate surface) facing toward outside of the light emission panel 30, and a second surface (or second plate surface) opposite to the first surface. The diffusion regions 502 are dispersed at least within one of the surfaces (or one of the two oppositely facing surfaces) of the base 501. In the case where the diffusion regions 502 are dispersed within a single surface of the base 501, the diffusion regions 502 are formed in the surface distal (or situated away) from the light emission panel 30, that is, in the first surface facing toward the outside of the light emission panel 30. However, the present invention is not limited in this respect, and as shown in FIG. 4, diffusion regions 502′ may be dispersed in both of the first and second surfaces of the base 501. The diffusion regions 502 occupy 2% or more of an overall volume of the base 501. In one embodiment, if a volume of the diffusion regions 502 is too low (e.g., less than 2% of the overall volume of the base 501), an insufficient light diffusion effect is obtained. By contrast, in another embodiment, if too many of the diffusion regions 502 are dispersed within the base 501, since light is excessively diffused, the effect achieved by independently driving the light emission pixels may be lost.

The base 501 primarily transmits the light emitted from the light emission panel 30 while the diffusion regions 502 primarily diffuse this light. Accordingly, a transmissivity of the base 501 is greater than a transmissivity of the diffusion regions 502, and the base 501 and the diffusion regions 502 have different refractive indexes. A ratio of the refractive index of the diffusion regions 502 to the refractive index of the base 501 of 1.2 or greater ensures that light diffusion is effectively realized, that is, that the light is widely diffused.

The light emitted from the light emission panel 30 (indicated by the arrows in FIG. 3) travels substantially in straight paths to reach the diffusion member 50. The base 501 of the diffusion member 50 allows for the transmission of the light therethrough in a forward direction (e.g., from the second surface of the base 501 to the first surface of the base 501), and at the same time (or substantially the same time), diffuses the light in accordance with the refractive index of the material forming the base 501. In addition, the diffusion regions 502, in accordance with the refractive index thereof, function such that the light transmitted through the base 501 is evenly diffused from each of the diffusion regions 502.

The diffused light is emitted in such a manner that the light extends into an inactive region (or a predetermined inactive region) of the light emission panel 30. Accordingly, a uniform brightness may be ensured, and the inactive region is not visibly discernible. Further, by dispersing the diffusion regions 502 within only the surface of the base 501 (within only the two surfaces of the base 501 in the case of the embodiment of FIG. 4), the diffusion member 50 is more easily manufactured than if the diffusion regions 502 were dispersed throughout the base 501.

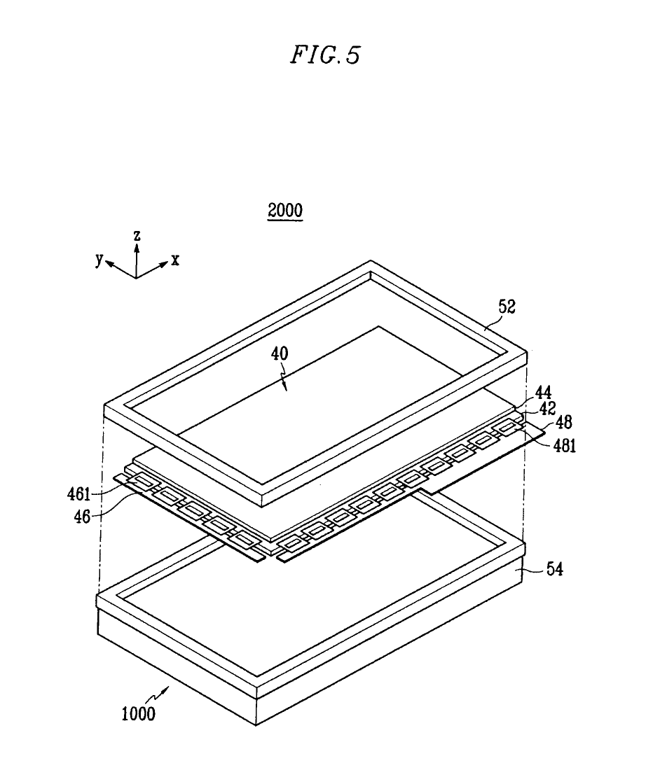

FIG. 5 illustrates an exploded partial perspective view of a display 2000 including the light emission device 1000 of FIG. 1 according to an exemplary embodiment of the present invention.

Referring to FIG. 5, the display 2000 includes the light emission device 1000 and a display panel 40 located on the light emission device 1000. The display panel 40 is secured on the light emission device 1000 by a third securing member 52.

The display panel 40 may be a liquid crystal panel or another type of non-emissive display panel. In the following description, the display panel 40 is assumed, by way of example, to be a liquid crystal panel.

The display panel 40 includes a thin film transistor (TFT) substrate 42 including a plurality of TFTs, a color filter substrate 44 located on the TFT substrate 42, and a liquid crystal layer formed of liquid crystals injected between the TFT substrate 42 and the color filter substrate 44. A polarizing plate is attached to an upper surface of the color filter substrate 44 and to a lower surface of the TFT substrate 42 to polarize light passed through the display panel 40.

The TFT substrate 42 is a transparent glass substrate on which TFTs are formed in a matrix configuration, and in which data lines are coupled to source terminals and gate lines are coupled to gate terminals. Further, pixel electrodes made of a transparent conductive film are formed on drain terminals.

Electrical signals are input to the gate lines and the data lines respectively from printed circuit boards 46 and 48. The electrical signals are input to the gate and source terminals of the TFTs, and the TFTs are turned on or off in accordance with the input of the electrical signals so that electrical signals for pixel formation are output to the drain terminals.

The color filter substrate 44 is a panel in which RGB pixels are formed in a thin film process to thereby realize colors (or predetermined colors) while allowing for light to pass therethrough. A common electrode formed of a transparent conductive film is deposited over an entire surface of the color filter substrate 44.

If electricity is applied to the gate and source terminals of the TFTs such that the corresponding TFTs are turned on, electric fields are formed between the pixel electrodes and the common electrode of the color filter substrate 44. As a result of these electric fields, alignment angles of the liquid crystals of the liquid crystal layer injected between the TFT substrate 42 and the color filter substrate 44 are altered, and, according to this change in the alignment of the liquid crystals, light transmissivities of the pixels are individually varied.

The printed circuit boards 46 and 48 of the display panel 40 are respectively coupled to the gate lines and the data lines through drive IC packages 461 and 481, respectively. In order to drive the display panel 40, the gate printed circuit board 46 transmits a gate drive signal, and the data printed circuit board 48 transmits a data drive signal.

The light emission panel 30 (see FIG. 1) included in the light emission device 1000 are formed to have a smaller number of pixels than the display panel 40 such that one of the pixels of the light emission panel 30 corresponds to two or more of the pixels of the display panel 40. Each of the pixels of the light emission panel 30 is able to display a gray scale corresponding to the highest gray scale of the corresponding plurality of pixels of the display panel 40. The light emission panel 30 is able to display gray levels in gray scale ranging from 2 to 8 bits for each of the pixels thereof.

For purposes of convenience of description, the pixels of the display panel 40 are referred to as first pixels, the pixels of the light emission panel 30 are referred to as second pixels, and the plurality of the first pixels corresponding to one of the second pixels are referred to as a first pixel group.

In operation, the light emission panel 30 is driven in the following manner. A signal controller for controlling the display panel 40 detects a highest gray level of the first pixels of the first pixel group, determines a gray level required for light illumination of the second pixel according to the detected gray level, converts this gray level into digital data, and generates a drive signal for the light emission device 1000 using this digital data. The drive signals of the light emission panel 30 include scan drive signals and data drive signals.

The printed circuit board 32 (see FIG. 3) of the light emission panel 30 is coupled to the drive IC packages 321 and 341 (see FIG. 1). To drive the light emission panel 30, the printed circuit board 32 transmits scan drive signals and data drive signals. Either the cathode electrodes 14 (see FIG. 2) or the gate electrodes 18 (see FIG. 2) receive the scan drive signals, and the other of the cathode electrodes 14 or the gate electrodes 18 receive the data drive signals.

The second pixels of the light emission panel 30 are synchronized with the corresponding first pixel groups when the first pixel groups display images to thereby perform light emission at certain gray levels (or predetermined gray level). The light emission panel 30 may be formed to have from 2 and 99 pixels in a row direction and in a column direction. If the number of the pixels of the light emission panel 30 in the row direction and in the column direction exceeds 99, driving of the light emission panel 30 becomes complicated and costs associated with the manufacture of the drive circuitry thereof are increased.

In the light emission device according to the exemplary embodiments of the present invention described above, the light emission intensities of the pixels may be independently controlled such that a suitable intensity of light may be supplied to each of the pixels of the display panel. Further, through use of the diffusion member having separate diffusion regions, the light emitted from the light emission panel is uniformly diffused over the entire surface of the display panel to thereby ensure uniform brightness. Hence, the display of the present invention is able to obtain an enhanced dynamic contrast, thereby realizing a display with sharper images.

In the light emission device according to an embodiment of the present invention, through use of the diffusion member including materials of differing refractive indexes, the diffusion of the light emitted from the light emission device is improved (or maximized), thereby allowing for the supply of light of a uniform brightness. This ensures that the brightness over the light emission surface is uniform such that, ultimately, the display quality of the display (or the display device) utilizing the light emission device of the present invention is improved. Furthermore, the display utilizing the light emission device of the present invention as a light source realizes an enhanced screen dynamic contrast such that power consumption of the light emission device, as well as the entire size of the display can be reduced.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emission device, comprising:
an electron emission-type light emission panel for emitting light; and
a diffusion member located on the light emission panel and for diffusing the light emitted from the light emission panel,
wherein the diffusion member comprises:
a base having a first refractive index, and comprising two oppositely facing surfaces; and
a diffusion region located in at least one of the surfaces of the base, and having a second refractive index differing from the first refractive index.

2. The device of claim 1, wherein a light transmissivity of the base is greater than a light transmissivity of the diffusion region.

3. The device of claim 1, wherein the diffusion region is located in each of the two surfaces of the base.

4. The device of claim 1, wherein the at least one of the surfaces faces toward an outside of the light emission device.

5. The device of claim 1, wherein a ratio of the second refractive index to the first refractive index is not less than about 1.2.

6. The device of claim 1, wherein the diffusion region comprises a plurality of beads.

7. The device of claim 6, wherein a diameter of the beads is in a range from 0.1 μm to 100 μm.

8. The device of claim 1, wherein the diffusion region occupies not less than 2% of an overall volume of the base.

9. The device of claim 1, wherein the light emission panel comprises:
a first substrate;
a second substrate opposing the first substrate;
a light emission unit provided on the second substrate for emitting light; and
an electron emission unit provided on the first substrate for emitting electrons toward the second substrate.

10. The device of claim 9, wherein the electron emission unit comprises:
a cathode electrode located on the first substrate;
an electron emission region adapted to be electrically coupled to the cathode electrode; and
a gate electrode electrically insulated from the cathode electrode.

11. A light emission device, comprising:
an electron emission-type light emission panel for emitting light; and
a diffusion member located on the light emission panel and for diffusing the light emitted from the light emission panel,
wherein the diffusion member comprises a plurality of beads, the beads being concentrated at a plate surface of the diffusion member.

12. The device of claim 11, wherein the plate surface of the diffusion member faces toward an outside of the light emission device.

13. The device of claim 11, wherein the diffusion member comprises:
a base; and
a diffusion region comprising the plurality of the beads,
wherein the light emitted from the light emission panel passes through the 10 base and is diffused by the diffusion member.

14. The device of claim 11, wherein the light emission panel comprises:
a plurality of active regions for emitting light; and
an inactive region located between the active regions in a lattice configuration,
wherein the light is diffused to the inactive region by the diffusion member.

15. A display device, comprising:
an electron emission-type light emission panel for emitting light;
a diffusion member located on the light emission panel and for diffusing the light emitted from the light emission panel; and
a display panel located on the diffusion member and for receiving the light passing through and diffused by the diffusion member,
wherein the diffusion member includes:
a base having a first refractive index, and comprising two oppositely facing surfaces; and
a diffusion region located in at least one of the surfaces of the base, and having a second refractive index differing from the first refractive index.

16. The device of claim 15, wherein a light transmissivity of the base is larger than a light transmissivity of the diffusion region.

17. The device of claim 15, wherein the diffusion region is located in each of the two surfaces of the base.

18. The device of claim 15, wherein the at least one of the surfaces faces toward an outside of the light emission device.

19. The device of claim 15, wherein a ratio of the second refractive index to the first refractive index is not less than 1.2.

20. The device of claim 15, wherein the display panel is a liquid crystal panel.
